(19) United States
(12) Patent Application Publication
(10) Pub. No.: US 2018/0137304 A1
(43) Pub. Date: May 17, 2018

(54) CONTACTS ACCESS METHOD AND DEVICE FOR MANAGING CONTACTS

(71) Applicant: BOE TECHNOLOGY GROUP CO., LTD., Beijing (CN)

(72) Inventors: Junjie ZHAO, Beijing (CN); Yongzhong ZHANG, Beijing (CN)

(21) Appl. No.: 15/795,300

(22) Filed: Oct. 27, 2017

(30) Foreign Application Priority Data
Nov. 17, 2016 (CN) 201611025954.3

(51) Int. Cl. G06F 21/62

(52) U.S. Cl. CPC G06F 21/6245

(57) ABSTRACT

The present invention discloses a contacts access method and a device for managing contacts. The method comprises receiving an access request for contacts from a requester; and providing a part of the contacts according to access privilege of the requester.

### CROSS-REFERENCE TO RELATED APPLICATION

The present application claims priority to Chinese Patent Application No. 201611025954.3 filed on Nov. 17, 2016, the disclosure of which is hereby incorporated by reference in its entirety.

### TECHNICAL FIELD

The present disclosure relates to the field of computer technology, more particularly, to a contacts access method and a device for managing contacts.

### BACKGROUND

Currently, when requesting for contacts information of a user, a requester for the contacts information may acquire all contents of the contacts information. However, some of the contacts information may involve privacy of the user. Providing these contents to the requester may cause leakage of the user's privacy.

It can be seen that the security of the contacts information is low and there is a risk of leaking user's privacy in the current technique of managing the contacts.

### SUMMARY

In view of the above problem, the present disclosure provides a contacts access method comprising receiving an access request for the contacts from a requester and providing a part of the contacts according to access privilege of the requester.

According to a second aspect of the present disclosure, a device for managing contacts is provided, which comprises a storage device for storing the contacts; and a processor configured to, in order to manage access to the contacts stored in the storage device, receive an access request for the contacts from a requester; and provide a part of the contacts according to access privilege of the requester.

### BRIEF DESCRIPTION OF THE FIGURES

In order to explain the technical solutions of embodiments of the present disclosure more clearly, drawings of the embodiments will be described briefly below. Obviously, drawings as described below relates to only some embodiments of the present disclosure, not limitation to the present disclosure.

FIG. 1 is a schematic flow chart of a contacts access method according to an embodiment of the present disclosure;

FIG. 2 is a schematic flow chart of an example of a contacts access method according to an embodiment of the present disclosure;

FIG. 3 is a schematic flow chart of an example of a contacts access method according to an embodiment of the present disclosure;

FIG. 4 is a structural diagram of a device for managing contacts according to an embodiment of the present disclosure;

FIG. 5 is a structural diagram of a device for managing contacts according to an embodiment of the present disclosure;

FIG. 6 is a structural diagram of a device for managing contacts according to an embodiment of the present disclosure; and

FIG. 7 is a schematic diagram of groups in the contacts according to an embodiment of the present disclosure.

### DETAILED DESCRIPTION

The technical solutions of embodiments of the present disclosure will be described clearly and thoroughly below in conjunction with accompanying drawings. Obviously, the embodiments to be described are not all of, but only part of the embodiments of the present disclosure. Other embodiments, which are obtained without any creative effort by an ordinary person skilled in the art based on the embodiments in the present disclosure, should fall into the protective scope of the present disclosure.

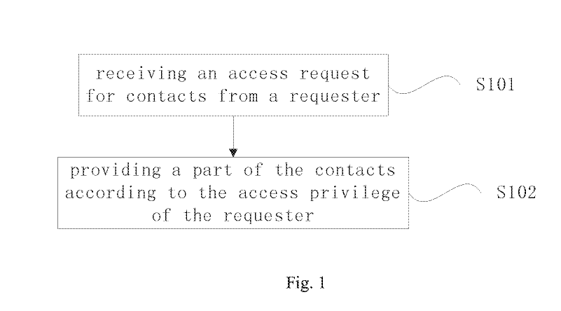

FIG. 1 is a schematic flow chart of a contacts access method according to an embodiment of the present disclosure. As shown in FIG. 1, the contacts access method according to an embodiment of the present disclosure comprises receiving an access request for contacts from a requester (S101), and providing a part of the contacts according to access privilege of the requester (S102).

In embodiments of the present disclosure, the requester refers to a subject requesting access to contacts information. Specifically, for example, one terminal may access contacts on another terminal, or an application (APP) in one terminal may access contacts stored in the same terminal, or one terminal may access contacts stored in a cloud platform server, or an external device may access contacts stored in a storage medium (i.e., a hard disk), etc.

In an embodiment of the present disclosure, the access request refers to a request initiated by the requester for acquiring information on contacts, specifically, for example, a request initiated by an application (APP) for accessing information of contacts on a terminal, a request initiated by a terminal for accessing contacts stored on a cloud platform server, or the like.

According to an embodiment of the present disclosure, the terminal may be any electronic device with communication function, such as a mobile phone, a tablet, a computer, a smart watch, and so on.

According to an embodiment of the present disclosure, the contacts may include a plurality of contact entries which may be divided into a plurality of groups. In this case, step S102 may comprise: providing information of one or more groups of the contacts according to the access privilege of the requester. According to an embodiment of the present disclosure, each of the plurality of contact entries may be included in only one of the plurality of groups.

According to an embodiment of the present disclosure, the contacts may include at least one contact entry, each of which may include a plurality of fields. In this case, step S102 may comprise: providing information of one or more of the fields of the at least one contact entry according to the access privilege of the requester. According to an embodiment of the present disclosure, the plurality of fields may include two or more fields selected from family name, given name, contact number, user ID on network, email address, home address, note name, user group, birthday and web address of a contact person.

Step S102 may include at least the following three implementations:

in a first implementation, the contacts include a plurality of contacts groups, and one or more contacts groups is provided according to the access privilege;

in a second implementation, each contact entry in the contacts includes a plurality of fields, and one or more fields is provided according to the access privilege;

in a third implementation, the above two implementations are combined, that is, one or more fields of the contact entries in one or more contacts groups are provided according to the access privilege.

According to an embodiment of the present disclosure, the contacts may include, for example, three contacts groups of “family”, “colleagues” and “friends”. The “family” group includes contact information of a plurality of family members, the “colleagues” group includes contact information of a plurality of colleagues, and the “friends” group includes contact information of a plurality of friends. If the access privilege of the requester is limited to only “colleagues” group, only the contact information of the colleagues will be provided.

According to an embodiment of the present disclosure, the contacts may include two contacts groups of “high privilege” and “low privilege”, for example. The “low privilege” group includes only name and contact information of a contact person. The “high privilege” group may include information involving privacy such as home address, identity (e.g., family member) of a contact person and the like, in addition to name and contact information of a contact person. If the access privilege of the requester is only limited to the access to the “low privilege” group, only name and contact information of a contact person in the “low privilege” group will be provided.

According to an embodiment of the present disclosure, each contact entry in the contacts may include four fields of name, contact information, home address and identity of a contact person, for example. If the access privilege of the requester is only limited to the access to two fields of name and contact information of a contact person, only the contents of two fields of name and contact information of a contact person will be provided.

According to an embodiment of the present disclosure, the contacts may include, for example, two contacts groups of “family” and “colleagues”. The “family” group may include a plurality of the fields including name, contact information, home address, nickname, photo of each family member. The “colleagues” group may include a plurality of the fields including name, contact information, work email address, work address of each colleague, and so on. If the access privilege of the requester is only limited to the access to the fields of name, contact information and work email address of the “colleagues” group, only the contents of three fields of name, contact information and work email address of the “colleagues” group will be provided.

According to an embodiment of the present disclosure, the plurality of the contacts groups may include a first contacts group and a second contact groups. Each contact entry in the first contacts group may include one or more fields selected from the fields of family name, given name, contact number, user ID on network, email address, home address, note name, user group, birthday and web address of a contact person. Each contact entry in the second contacts group may include one or more fields selected from the fields of family name, given name, contact number, user ID on network, email address, home address, note name, user group, birthday and web address. For example, each contact entry in the first contacts group may include three fields of family name, given name and contact number, and each contact entry in the second contacts group may include ten fields of family name, given name, contact number, user ID on network, email address, home address, note name, user group, birthday and web address. If the access privilege of the requester is only limited to the access to the first contacts group, only contents of family names, given names and contact numbers of the first contacts group will be provided. According to an embodiment of the present disclosure, the contact persons in the first contacts groups may coincide with those in the second contacts groups. Alternatively, the contact persons in the first contacts groups may not coincide with those in the second contacts groups.

According to an embodiment of the present disclosure, the first contacts group may not coincide in contents with the second contacts group. “Not coincide in contents” means that: the fields of each contact entry in the first contacts group do not completely overlap with those in the second contacts group; or, the fields of each contact entry in the first contacts group and the fields of each contact entry in the second contacts group do not overlap at all; or the fields of each contact entry in the first contacts group coincide with those in the second contacts group whereas the contact entries in the two contacts groups do not coincide with each other. For example, in the case that the fields of each contact entry in the first contacts group do not completely overlap with those in the second contacts group, each contact entry in the first contacts group may include three fields of family name, given name and contact number of the contact person, and each contact entry in the second contacts group may include six fields of family name, given name, contact number, user ID on network, email address and home address of the contact person, wherein only three fields of family name, given name and contact number coincide between the first and second contacts groups while other fields do not coincide. For example, in the case that the fields of each contact entry in the first contacts group and the fields of each contact entry in the second contacts group do not overlap at all, each contact entry in the first contacts group may include three fields of family name, given name and contact number of the contact person, and each contact entry in the second contacts group may include two fields of email address and home address. For example, in the case that the fields of each contact entry in the first contacts group coincide with those in the second contacts group whereas the contact entries in the two contacts groups do not coincide with each other, each contact entry in the first contacts group may include three fields of family name, given name and contact number of the contact person, and each contact entry in the second contacts group may also include three fields of family name, given name and contact number of the contact person; however, the first contacts group may include only the contact person “San ZHANG” whereas the second contacts group may include the contacts persons “San ZHANG” and “Si LI”.

According to the contacts access method of the embodiment of the present disclosure, a determination of whether corresponding field contents will be provided may be made for each field of the contact entry according to the access privilege of the requester, and thereby stricter access control can be provided.

The contacts access method according to an embodiment of the present disclosure may further comprise setting a first attribute for each of the plurality of fields, the first attribute indicating whether the field is accessible. The first attribute of a field may be set to indicate that the field is accessible to all requesters, or to indicate that the field is accessible only to requesters with high security level and is inaccessible to requesters with low security level. For example, the first attributes of the two fields of family name and given name may be set to indicate that information on family name and given name of a contact person is accessible to all requesters. For example, the first attribute of the field of home address may be set to indicate that this field is accessible only to the requesters with high security level and is inaccessible to the requesters with low security level. A requester with high security level may include, but not limited to, e.g., a device used by the system administrator account, and a requester with low security level may include, but not limited to, e.g., a device used by an ordinary user. According to an embodiment of the present disclosure, the first attribute of each field may be set for each requester to indicate whether this field is accessible to the requester.

According to an embodiment of the present disclosure, the first attribute of a field may be set according to a setting instruction inputted by a user or according to an attribute configuring rule before an access request for the contacts from the requester is received. Then, when the access request from the requester is received, it is determined whether the field is accessible to the requester according to the set first attribute. According to an embodiment of the present disclosure, the first attribute of a field may be set dynamically according to an attribute configuring rule after an access request for the contacts from the requester is received. For example, if a requester identifier carried in the access request indicates that the requester is the system administrator, the first attribute of the field of home address is set automatically as accessible to the system administrator according to the attribute configuring rule, i.e., the content of the field of home address is accessible to this requester. If a requester identifier carried in the access request indicates that the requester is an ordinary user, the first attribute of the field of home address is set automatically as inaccessible to the ordinary user according to the attribute configuring rule, i.e., the content of home address is inaccessible to this requester.

The contacts access method according to an embodiment of the present disclosure may further comprise setting a second attribute for each of the plurality of fields, the second attribute indicating whether the field is visible. The second attribute of a field may be set to indicate that this field is visible to all requesters, or to indicate this field is visible to the requesters with high security level and is not visible to the requesters with low security level. For example, the second attribute of the field of photo may be set to indicate that this field is visible to the requesters with high security level and is not visible to the requesters with low security level. A requester with high security level may include, but not limited to, e.g., a device used by the system administrator account, and a requester with low security level may include, but not limited to, e.g., a device used by an ordinary user. According to an embodiment of the present disclosure, the second attribute of each field may be set for each requester to indicate whether this field is visible to the requester. Herein, “whether the field is visible” means whether to present the contents of the field to the requester after the field is accessed by the requester. For example, the first attribute of the field of photo may be set as accessible, and the second attribute thereof may be set as invisible. For the field of photo set as such, the requester may acquire only the field name of “photo”, and cannot see the content of the photo.

The contacts access method according to an embodiment of the present disclosure may further comprise determining the access privilege of the requester before step S102. For example, the access privilege of the requester may be determined according to requester information carried in an authentication request sent by the requester. If it is determined that all fields of the contact entries of the contacts is accessible to the requester, the contents of all fields may be provided to the requester.

According to an embodiment of the present disclosure, the access privilege of the requester may be determined according to an identifier of the requester carried in the access request, wherein the identifier includes at least one of a role identifier and an identity identifier. The role identifier may be used to represent role information of the requester, such as the visitor user, the ordinary user, the administrator user, and so on. The identity identifier may be used to represent identity information of the requester, such as the system software of Company A, the instant communication software of Company B, the mobile phone used by User C, and so on.

According to an embodiment of the present disclosure, the access privilege of the requester may be determined according to an access password sent by the requester. For example, after the requester provides a correct access password, all information of the contacts may be provided to the requester. For example, some information of the contacts may be provided to the requester directly, and after the requester provides the correct access password, other information which is encrypted is provided to the requester. For example, after it is determined that the requester has no access to some or all contents of the contacts according to the identifier of the requester, the contents that are inaccessible will be provided to the requester if the requester provides the correct access password.

The contacts access method according to an embodiment of the present disclosure may further comprise setting the access privilege of the requester. According to an embodiment of the present disclosure, the access privilege may be set with respect to a specific requester. For example, when a requester is the mobile phone used by User C, an access privilege of acquiring only the “colleagues” group of the contacts may be set for this mobile phone; or an access privilege of acquiring only the three fields of family name, given name and contact information may be set for this mobile phone; or an access privilege that all fields are accessible but only the three fields of family name, given name and contact information are visible may be set for this mobile phone.

According to an embodiment of the present disclosure, the step of setting the access privilege of the requester may comprise setting, in a case that the requester is an application, the access privilege of the application when the application is installed. According to an embodiment of the present disclosure, the access privilege of the application may be set according to an authorization instruction inputted by a user. For example, when the instant communication software of Company B is installed, the access privilege of this software may be set according to an authorization instruction inputted by the user indicating that only the “colleagues” group of the contacts is available by this software.

According to an embodiment of the present disclosure, the step of setting the access privilege of the requester may comprise determining, in a case that the requester is an application, security information of the application when or after the application is installed, and setting the access privilege of the application according to the security information. For example, when or after the application of Company C is installed, the terminal on which the application is installed recognizes that this software has a low security level, and thus this software may be set such that the contacts are inaccessible to the software. For example, when an application of Company D is installed on a terminal device of Company D, this software may be set such that all contents of the contacts are accessible to the software. For example, when or after an application of Company E is installed, the terminal recognizes that this application is an office software, and thus this software may be set such that only the contents of the “colleagues” group of the contacts are accessible to the software.

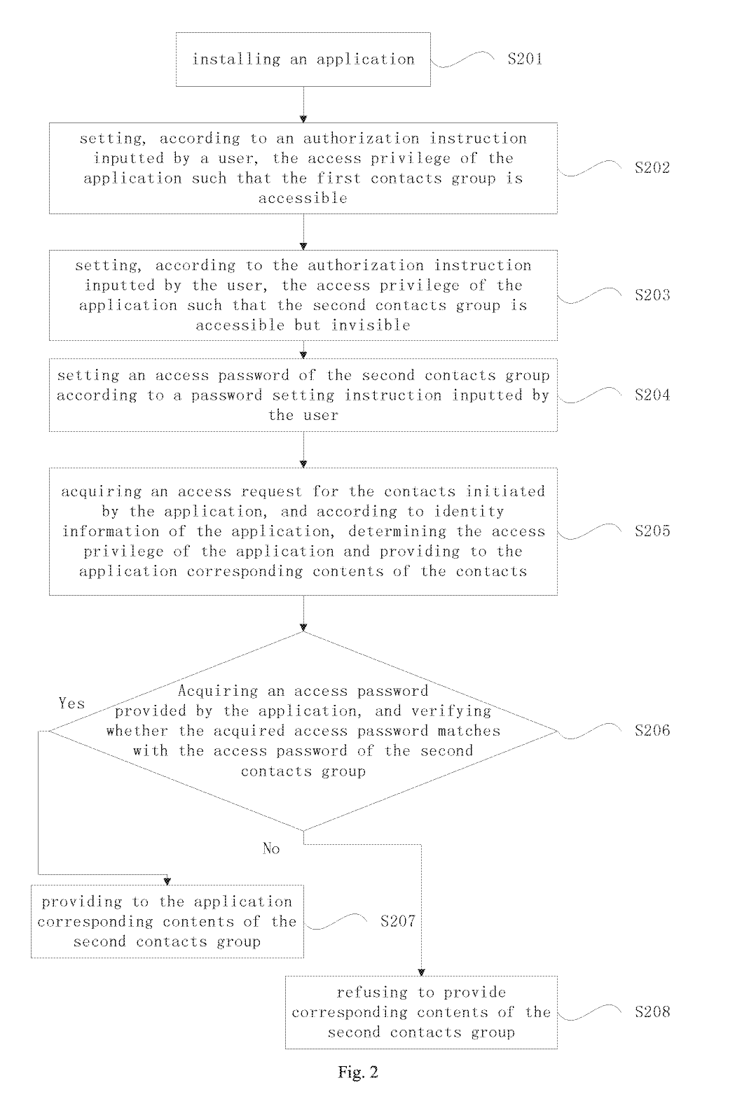

FIG. 2 is a schematic flow chart of an example of a contacts access method according to an embodiment of the present disclosure. As shown in FIG. 2, this example may comprise: installing an application (S201); setting, according to an authorization instruction inputted by a user, an access privilege of the application such that a first contacts group is accessible to the application (S202); setting, according to the authorization instruction inputted by the user, the access privilege of the application such that a second contacts group is accessible but is invisible to the application (S203); setting an access password of the second contacts group according to a password setting instruction inputted by the user (S204); acquiring an access request for the contacts initiated by the application, and according to an identity information of the application carried in the access request, determining the access privilege of the application and providing to the application the contents of fields of each contact entry in the first contacts group and names of fields of each contact entry in the second contacts group (S205); acquiring an access password provided by the application, and verifying whether the acquired access password matches with the access password of the second contacts group (S206); if they match with each other, providing to the application the contents of the fields of each contact entry in the second contacts group (S207), and if they do not match with each other, refusing to provide the contents of the fields of each contact entry in the second contacts group (S208).

According to an embodiment of the present disclosure, the subject performing the examples of the method may be a terminal device such as a mobile phone, a tablet, a computer, and so on. Installed application may be an instant communication software, for example.

FIG. 7 is a schematic diagram of the groups in the contacts applicable to the present embodiment.

As shown in FIG. 7, for example, the contacts may be divided into a first contacts group (the contacts group 1) and a second contacts group (the contacts group 2). There is only a field of contact number in the contacts group 1, whereas fields of name, user group, email address, address and so on are included in the contacts group 2.

For example, after an instant communication software is installed, a terminal may receive the authorization instruction inputted by the user, and authorize the instant communication software to have access to the contacts group 1 according to the authorization instruction so that the instant communication software can acquire the contents of the field of contact number (e.g., 20 mobile phone numbers). The instant communication software may match automatically the acquired contents of the field of contact number with corresponding instant communication accounts, and display the instant communication accounts on the terminal. In addition, according to the authorization instruction inputted by the user, the contacts group 2 may be accessible to the instant communication software, but its contents are invisible to the instant communication software. When the instant communication software runs, the instant communication software initiates an access request for the contacts, the access request carrying the identity identifier of the software. According to the identity identifier, it is determined that the access privilege of the software is as follows: the contacts group 1 is accessible and the contacts group 2 is accessible but invisible to the software. Thus, for each contact entry in the contacts group 2, only the names of its fields can be acquired, but the specific contents of its fields cannot be acquired. If there is an access password carried in the access request, it is verified whether the carried access password matches with the access password set for the contacts group 2. If they match with each other, the contents of the fields of each contact entry in the contacts group 2 is provided to the software.

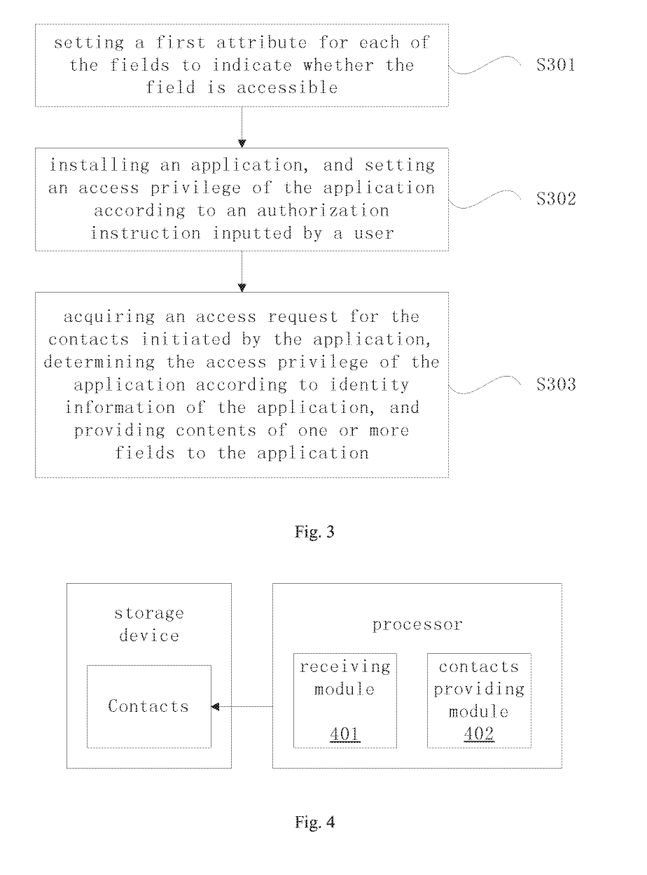

FIG. 3 is a schematic flow chart of an example of a contacts access method according to an embodiment of the present disclosure. As shown in FIG. 3, this example may comprise the following steps: setting a first attribute for each of the fields to indicate whether the field is accessible (S301); installing an application, and setting an access privilege of the application according to an authorization instruction inputted by a user (S302); and acquiring an access request for the contacts initiated by the application., determining the access privilege of the application according to identity information of the application carried in the access request, and providing contents of one or more fields to the application (S303).

Table 1 shows how to set the first attribute of each field by way of example.

TABLE 1

| | Contact person | Contact | e-mail | | |
|---|---|---|---|---|---|
| Fields | name | number | address | nickname | address |
| Application 1 | No | Yes | No | No | No |
| Application 2 | No | No | No | No | No |
| Application 3 | Yes | Yes | Yes | Yes | Yes |
| . . . | . . . | . . . | . . . | . . . | . . . |

In the example of Table 1, each contact entry of the contacts includes the fields of contact person name, contact number, email address, nickname, and address. For Application 1, only the field of contact number is accessible. For Application 2, all fields are inaccessible. For Application 3, all fields are accessible. Applications 1 to 3 may refer to certain applications, or certain types of applications such as office software.

For example, when or after Application G is installed, Application G is indicated to have access to all contacts according to the authorization instruction inputted by the user. However, since the first attribute of each field has been set in step S301, the access privilege of Application G is limited to acquirement of the contents of the field of contact person name if it is determined that Application G is Application 1. According to an embodiment of the present disclosure, the user may simply authorize the requester to access the entire contacts, and what contents the requester may actually acquire needs to be determined according to the first attribute and/or the second attribute of each field in the contacts and the groups included in the contacts.

For example, when or after Application G is installed, Application G is indicated to only have access to the field of address according to the authorization instruction inputted by the user. However, since the first attribute of each field has been set in step S301, the access privilege of Application G set by the authorization of the user conflicts with the first attributes of the fields if it is determined that Application G is Application 1. According to an embodiment of the present disclosure, if such conflict occurs, actual access capability of the requester may be determined according to a preset rule in which, for example, the priority is given to the authorization of the user, or the priority is given to the attributes of the fields.

FIGS. 4 to 6 are structural diagrams of devices for managing the contacts according to embodiments of the present disclosure.

As shown in FIG. 4, a device for managing the contacts according to an embodiment of the present disclosure comprises a storage device for storing contacts; and a processor configured as the following functional modules to manage access to the contacts stored in the storage device: a receiving module 401 for receiving an access request for contacts from a requester; and a contacts providing module 402 for providing a part of the contacts according to access privilege of the requester.

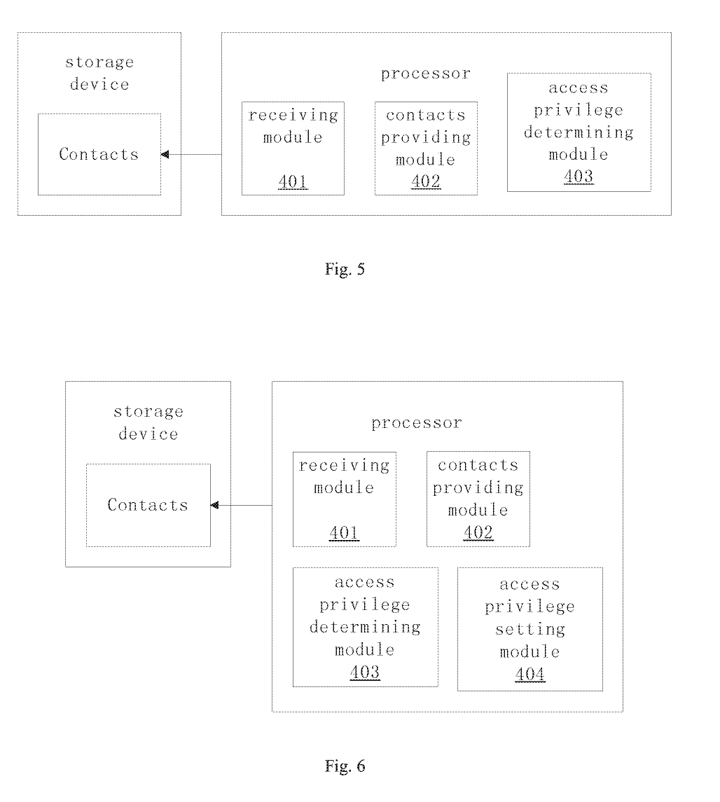

As shown in FIG. 5, the processor of the device for managing the contacts according to an embodiment of the present disclosure may be further configured as an access privilege determining module 403 for determining the access privilege of the requester. The access privilege determining module 403 may determine the access privilege of the requester according to an access password sent by the requester, or according to an identifier carried in the access request. The identifier may include at least one of a role identifier and an identity identifier. The receiving module 401 may be used for receiving the access password or the identifier sent by the requester.

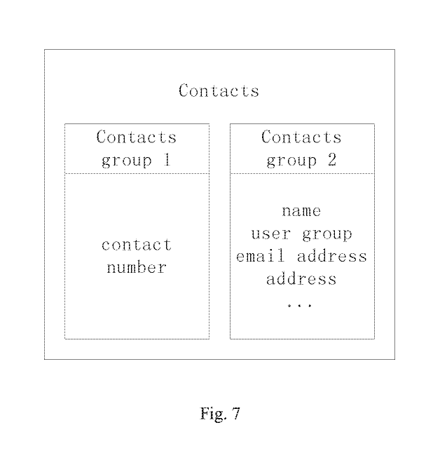

As shown in FIG. 6, the processor of the device for managing the contacts according to an embodiment of the present disclosure may be further configured as an access privilege setting module 404 for setting the access privilege of the requester.

The device for managing the contacts according to an embodiment of the present disclosure may be any terminal or server with wireless communication function, such as (but not limited to) a mobile phone, a computer, a tablet, a smart watch, and a cloud platform server providing cloud storage service.

A skilled person in the art may realize various specific implementations and various variations of the device for managing the contacts according to embodiments of the present disclosure. The protective scope of the present disclosure is intended to encompass all these implementations and the variations thereof.

In the above embodiments, it is described that the processor may be configured as various functional modules; however, these functional modules may be implemented as separate hardware circuits. For example, the above various functional modules may be implemented by various semiconductor chips, transistors, or other discrete components, or may be implemented by Field Programmable Gate Array, Programmable Array Logic, Programmable Logic Device, or the like. In addition, the above various functional modules may be implemented by the combination of software (or firmware) and hardware.

What is claimed is:

1. A contacts access method, comprising:
receiving an access request for the contacts from a requester; and
providing a part of the contacts according to access privilege of the requester.

2. The contacts access method of claim 1, wherein the contacts include a plurality of contact entries which are divided into a plurality of groups, and the step of providing a part of the contacts according to the access privilege of the requester comprises:
providing information of one or more groups of the contacts according to the access privilege of the requester.

3. The contacts access method of claim 2, wherein each of the plurality of contact entries is included in only one of the plurality of groups.

4. The contacts access method of claim 1, wherein the contacts include at least one contact entry, each of which includes a plurality of fields, and the step of providing a part of the contacts according to the access privilege of the requester comprises:
providing information of one or more of the fields of the at least one contact entry according to the access privilege of the requester.

5. The contacts access method of claim 4, wherein the plurality of fields include two or more fields selected from family name, given name, contact number, user II) on network, email address, home address, note name, user group, birthday and web address of a contact person.

6. The contacts access method of claim 4, further comprising:
setting a first attribute for each of the plurality of fields, the first attribute indicating whether the field is accessible.

7. The contacts access method of claim 6, further comprising:
setting a second attribute for each of the plurality of fields, the second attribute indicating whether the field is visible.

8. The contacts access method of claim 1, further comprising:
determining the access privilege of the requester.

9. The contacts access method of claim 8, wherein the step of determining the access privilege of the requester comprises:
determining the access privilege of the requester according to an identifier of the requester carried in the access request, wherein the identifier includes at least one of a role identifier and an identity identifier.

10. The contacts access method of claim 8, wherein the step of determining the access privilege of the requester comprises:
determining the access privilege of the requester according to an access password sent by the requester.

11. The contacts access method of claim 8, wherein prior to determining the access privilege of the requester, further comprising:
setting the access privilege of the requester.

12. The contacts access method of claim 11, wherein the step of setting the access privilege of the requester comprises:
setting the access privilege of the requester according to an authorization instruction inputted by a user.

13. The contacts access method of claim 11, wherein the requester is an application, and the access privilege of the application is configured when installing the application.

14. A device for managing contacts, comprising:
a storage device for storing the contacts; and
a processor configured to, in order to manage access to the contacts stored in the storage device,
receive an access request for the contacts from a requester; and
provide a part of the contacts according to access privilege of the requester.

15. The device for managing contacts of claim 14, wherein the contacts include a plurality of contact entries which are divided into a plurality of groups, and the processor is further configured to provide information of one or more groups of the contacts according to the access privilege of the requester.

16. The device for managing contacts of claim 14, wherein the contacts include at least one contact entry, each of which includes a plurality of fields, and the processor is further configured to provide information of one or more of the fields of the at least one contact entry according to the access privilege of the requester.

17. The device for managing contacts of claim 16, wherein the plurality of fields include two or more fields selected from family name, given name, contact number, user ID on network, email address, home address, note name, user group, birthday and web address of a contact person.

18. The device for managing contacts of claim 14, wherein the processor is further configured to determine the access privilege of the requester,
wherein the processor determines the access privilege of the requester according to an access password sent by the requester or according to an identifier of the requester carried in the access request, wherein the identifier includes at least one of a role identifier and an identity identifier.

19. The device for managing contacts of claim 14, wherein the processor is further configured to set the access privilege of the requester.

20. The device for managing contacts of claim 19, wherein the processor is further configured to set the access privilege of the requester according to an authorization instruction inputted by a user.
